(19) United States
(12) Patent Application Publication
(10) Pub. No.: US 2026/0302828 A1
(43) Pub. Date: Oct. 1, 2026

(54) CONTINUOUS ELECTRICAL POWER SOURCE IN SWITCHED (NON-CONTINUOUS) ARTIFICIAL LIGHTING ENVIRONMENTS

(71) Applicant: Wandering Wolf Ventures Ltd., Nanaimo (CA)

(72) Inventor: David Moss, Nanaimo (CA)

(21) Appl. No.: 19/635,424

(22) Filed: Mar. 31, 2026

Related U.S. Application Data
(60) Provisional application No. 63/781,794, filed on Apr. 1, 2025.

(51) Int. Cl. H02J 9/06; H01M 50/24; H01M 50/251; H02J 7/02; H02J 101/10; H02J 101/24; H02J 101/28; H02J 101/30; H02J 107/20

(52) U.S. Cl. CPC H02J 9/065; H01M 50/24; H01M 50/251; H02J 7/02; H02J 2101/10; H02J 2101/24; H02J 2101/28; H02J 2101/30; H02J 2107/20; H02J 2207/20; H02J 2207/50

(57) ABSTRACT

A continuous electrical power supply for uninterrupted power to an electrical load from a periodically switched intermittent power source, comprising: an electrical energy storage device; a charger configured to receive electrical power from the power source and to charge the storage device during periods when the intermittent power source is energized; an output power circuit configured to supply electrical power from the storage device to the electrical load when the intermittent power source is or is not energized; and an enclosure housing the storage device, charger, and output power circuit; wherein the battery is sized to power the electrical load during periods when the intermittent power source is de-energized, and the charger is configured to recharge the storage device during a charging window corresponding to the energized period of the power source such that the electrical load receives substantially continuous electrical power.

### FIELD OF THE INVENTION

The present invention relates to the provision of a continuous electrical power source for any small electrical load where consistent, intermittent electrical power is available in an outdoor lighting environment. According to one embodiment, the invention relates to an electrical load that may run continuously on a streetlight pole whose electrical power source is only available during nighttime hours.

### BACKGROUND OF THE INVENTION

The transportation sector has an increasing demand to power small electrical loads on a continuous basis to gather data, monitor systems, provide video surveillance, enable intelligent transportation systems, enable safety systems, power irrigation controllers, and for other purposes. Traditionally, continuous electrical power is provided by a utility power service which includes a connection to the utility, metering, power distribution, device wiring, and ongoing invoicing with service fees. These utility power services incur engineering and design costs, initial capital costs, on-going maintenance costs, administrative costs, and invoicing service fees. It may take months or years to design, tender, construct, and commission this new infrastructure.

It would be desirable to avoid these costs and time delays by leveraging the existing streetlight infrastructure that already exists along many roadways and highways. These streetlights have existing utility power services that distribute power to each pole, but that power is usually only switched on at night to light the roadway. There is a need for an invention that collects electrical power from the streetlight utility power system during the night, stores that energy, and provides continuous power to the electrical load. The present invention addresses this need.

### SUMMARY OF THE INVENTION

There is provided a continuous electrical power supply apparatus for providing uninterrupted power to an electrical load from a periodically switched intermittent power source, comprising an electrical energy storage device; an electrical energy storage device charger configured to receive electrical power from the intermittent power source and to charge the electrical energy storage device during periods when the intermittent power source is energized; an output power circuit configured to supply electrical power from the electrical energy storage device to the electrical load when the intermittent power source is or is not energized; and an enclosure housing the electrical energy storage device, electrical energy storage device charger, and output power circuit; wherein the battery is sized to power the electrical load during periods when the intermittent power source is de-energized, and wherein the electrical energy storage device charger is configured to recharge the electrical energy storage device during a limited charging window corresponding to the energized period of the intermittent power source such that the electrical load receives substantially continuous electrical power.

The intermittent power source may be selected from the group of electrical lighting circuits comprising roadway electric lighting circuits, parking lot electric lighting circuits, tunnel electric lighting circuits, airport electric lighting circuits, and industrial yard electric lighting circuits that are energized during nighttime hours and de-energized during daytime hours.

The intermittent power source may be a fuel generator powered by an internal combustion engine, a fuel cell, or thermoelectric processes, a renewable resource such as solar, wind, or micro hydro.

The electrical storage device may be selected from the group of devices comprising a battery, a super capacitor, and an ultracapacitor. The battery may comprise a lead-acid battery or a rechargeable lithium iron phosphate battery configured for at least 3,650 deep discharge cycles.

The output power circuit may comprise a power converter configured to convert electrical energy storage device output power to a voltage or current type required by the electrical load. The power converter may comprise at least one of: a DC-AC converter, a DC-DC converter, a voltage regulator, a modified sine wave inverter, or a pure sine wave inverter.

The enclosure may be weatherproof and configured for outdoor installation on a pole, wall, or similar structure, and may comprise environmental conditioning components configured to maintain the internal components within an operational temperature range.

The environmental conditioning components may comprise at least one of a heater, fan, insulation layer, thermostat, or ventilation component. The enclosure may be custom designed to enclose the electrical load devices as well as the power source to reduce the required infrastructure at the installation site.

The charger may be configured to recharge the electrical energy storage device from a depleted state in less than six hours. The electrical energy storage device may be configured to supply electrical power to the electrical load for a duration of at least 12 and up to 18 hours without input power.

The apparatus may further comprise a receptacle configured to allow the electrical load to be connected by plug, and may include a communication module configured to provide wireless connectivity for monitoring or controlling the apparatus, wherein the communication module comprises at least one of a cellular modem, satellite modem, Bluetooth interface, Wi-Fi interface, or network interface.

The apparatus may further comprise a prewired power tap module configured to connect directly to a receptacle associated with a light fixture.

There is also provided a method of providing continuous electrical power to an electrical load from a switched intermittent power source, comprising: drawing electrical power from the intermittent power source during periods when the intermittent power source is energized; charging a battery with the drawn electrical power; supplying electrical power from the battery to the electrical load during periods when the intermittent power source is not energized; and repeating the charging and supplying steps on a daily cycle corresponding to the switching schedule of the intermittent power source.

The method may further comprises recharging the battery during a nighttime period and the electrical load is powered from the battery during a daytime period. The method may further include conditioning an interior environment of an enclosure containing the battery to maintain the battery above minimum charging and discharging temperatures.

### BRIEF DESCRIPTION OF THE DRAWINGS

A detailed description of the preferred embodiment is provided below by way of example only and with reference to the following drawings in which:

FIG. 1 is a plan view of the back panel layout of the invention;

FIG. 2 is a plan view of the front of the enclosure of the invention;

FIG. 3 is a plan view of the side of the enclosure of the invention;

FIG. 4 is a plan view of the bottom of the enclosure of the invention; and

FIG. 5 is a schematic of the wiring for the invention.

In the drawings, selected embodiments of the invention are illustrated by way of example. It is to be expressly understood that the description and drawings are only for the purpose of illustration and as an aid to understanding and are not intended as a definition of the limits of the invention.

### DETAILED DESCRIPTION OF THE INVENTION

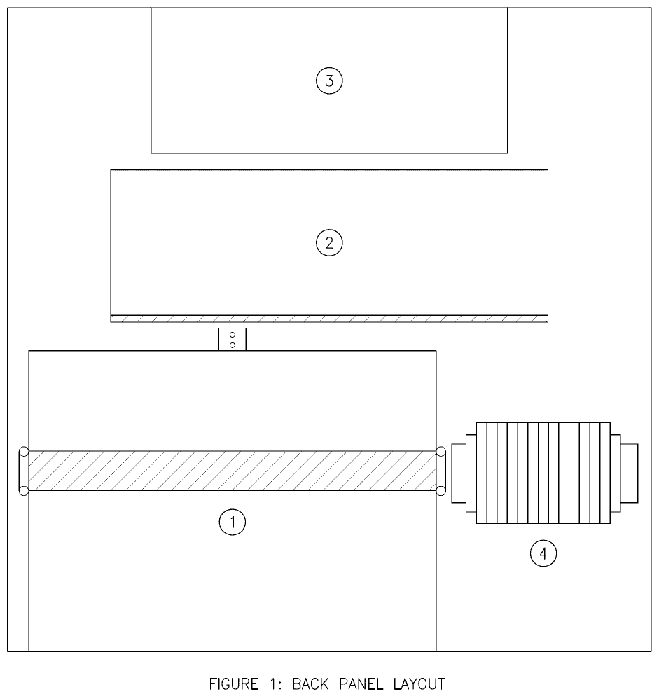

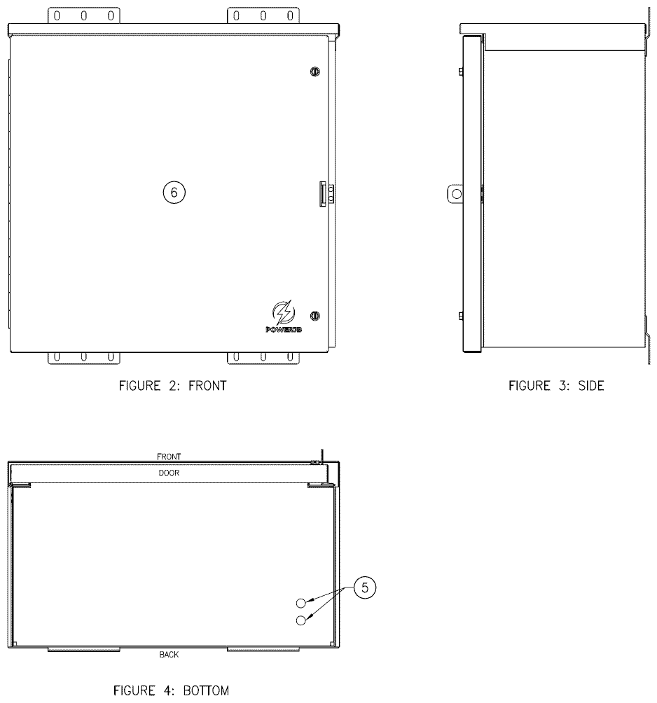

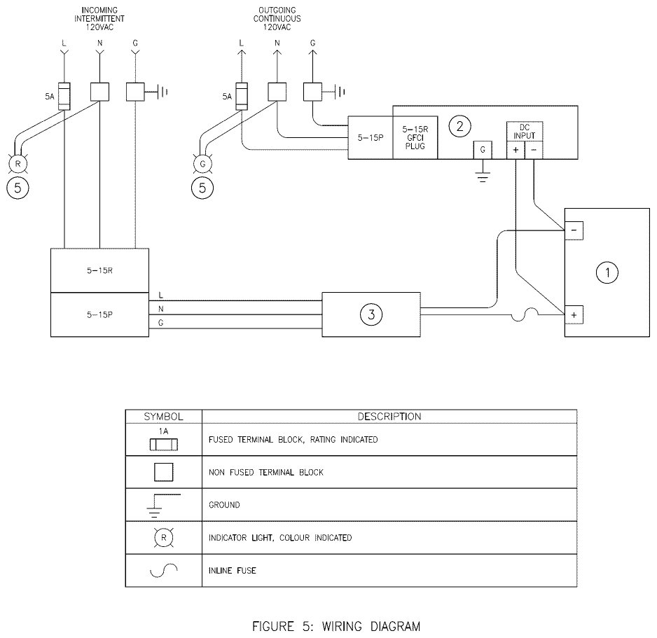

There is provided a continuous electrical power source comprising several typical components as illustrated in FIGS. 1 to 5 and described in Table 1 below:

TABLE 1
Description of Components Shown in FIG. 1

| Component | Name | Description |
|---|---|---|
| 1 | Battery | One or more high energy |
| | | density hardened batteries |
| | | rated for at least 3,650 |
| | | deep discharge cycles. |
| | | Battery is restrained by |
| | | horizontal adjustable strap |
| | | and top bracket. |
| 2 | Power | Hardened output power converter |
| | converter | (if required). |
| | | Typical converters include DC-DC converters, |
| | | voltage regulators, pure sine wave inverters, |
| | | and modified sine wave inverters. |
| | | The power converter may |
| | | include a transformer. A 12VDC to 120VAC |
| | | inverter is shown in the wiring diagram. |
| 3 | Charger | Hardened battery charger sized |
| | | for fast charging. |
| | | The charger may include a transformer. |
| 4 | Terminal | Terminal block for internal wiring, |
| | block | incoming power conductors, |
| | | and outgoing power conductors. |
| 5 | Indicator | LED indicator lights so that uses can |
| | light | confirm incoming and outgoing power |
| | | status from the outside of the enclosure. |
| 6 | Enclosure | Weatherproof enclosure |

The enclosure (6) provides protection for the remaining components from the environment including insulation, heating, and ventilation as required. Individual devices are not shown as they are specific to each device installation environment and the size of the enclosure. Typical devices include heaters, fans, polystyrene insulation, thermostats, and affiliated wiring. Heating and ventilation components operate automatically to maintain the temperature in the enclosure within the operating range for the enclosure's internal components. Enclosure size and weight is minimized to produce a small form factor that can be mounted to a pole, wall, or similar device.

The ideal enclosure dimensions range from 12″×12″×6″ for the smallest electrical loads up to 48″×36″×12″ for the largest electrical loads. Beyond this upper bound the wind loading may exceed the support capacity of most light poles without additional structural supports and associated civil work.

The ideal enclosure weight ranges from 3 kg for the smallest electrical loads up to 110 kg for the largest electrical loads. Beyond this upper bound the weight may be difficult to handle and install in most applications without additional structural supports and associated civil work.

The enclosure requires minimum void spaces around the components to allow for air circulation, device cooling, and convection heating.

The layout of components within the enclosure is configured to:
1. ensure that the mass of the battery is kept low to facilitate handling and minimize the need for supporting structures;
2. ensure that the power converter is kept low to ensure that it is exposed to less heat on hot days; and
3. place the charger near the top as it will only operate during nighttime hours when lower daily temperatures (and thus associated internal temperatures) are expected.

The terminal block (4) is where wire terminations occur for internal wiring, incoming power conductors, and outgoing power conductors. An installer of the invention in the field will be required to terminate the incoming and outgoing power conductors.

Input power from the artificial lighting power source flows into the battery charger (3). Depending on the incoming voltage of the artificial lighting power source, a small transformer may be required as part of the charger. The battery charger charges the battery by controlling the charging voltage and charging current as required by the battery chemistry and configuration. The current draw of the electrical load (potentially via the power converter if so equipped) is also supplied by the charger during the charging stage. The charger can accept alternating current voltages from 20V to 1000V and direct current voltages from 12V to 60V depending on the application.

The battery (1) receives electrical energy from the charger and stores this energy chemically. The battery then delivers electrical energy directly to the electrical load for electrical loads that are the same voltage as the battery or to the power output converter. The battery produces and accepts direct current and may have a voltage range from 6V to 60V depending on the application.

The power output converter (2) (if required) converts the output electrical energy from the battery to the desired voltage and/or alternating current which is supplied to the electrical load. Depending on the required output voltage for the electrical load, a small transformer may be required as part of the power converter. The power converter can produce alternating current voltages from 20V to 1000V and direct current voltages from 5V to 60V depending on the application.

The status lights (5) provide a visual indication on the bottom of the enclosure indicating the status of the device. The incoming status light is only lit when the artificial lighting power source is on. The outgoing status light is only lit when the continuous output from the invention is active.

The invention provides several functions, including an inverted uninterruptible power supply. The invention may at first seem similar to the prior art for Uninterruptible Power Supplies (UPS) but in fact it provides an inverse function.

UPSs are designed to provide continuous electrical power in a system where the input electrical power is reliably available most of the time (generally 99% or higher uptime). A UPS only provides power for short periods of time (usually only a matter of minutes at full load) infrequently when there is a brown-out or power outage on the utility power grid. For critical applications, longer outages are supported by a generator such that the UPS only provides power for the brief period to transition from utility to generator input and vice versa.

The invention on the other hand provides continuous power to electrical loads in an environment where the input power is switched off regularly (every day) for long periods of time (many hours). This difference requires the invention to include three distinguishing features:
1. A larger energy storage device relative to the size of the electrical load as the load must run for large portions of each day (up to 18 hours) without any input power source.
2. Fast charging times. A typical UPS can take days to recharge its batteries after a deep discharge because power outages are typically infrequent. The invention must complete a full recharge from a depleted state in less than 6 hours each day.
3. An energy storage system that cycles every single day instead of a few times a year. The invention energy storage system is intended to last for over 10 years and as such must have a lifespan of more than 3,650 deep discharge cycles whereas a typical UPS uses lead-acid batteries that only last for 200 deep discharge cycles. A deep discharge is defined as a discharge of at least 80% of the stored energy.

The present invention provides consistent, predictable performance. The prior art includes devices that have a similar architecture to the invention but are designed and intended for input power from renewable energy sources such as solar photovoltaics or wind generation. These renewable sources are intermittent and unpredictable. As a result, these systems must have low power outputs and/or large battery banks to compensate for long periods of unavailable power generation (for solar generation: short daylight hours in the winter or cloudy days; for wind generation: low or absent wind for prolonged periods). If these outage periods extend beyond the design timeline, these systems cease producing power for their electrical loads. The invention differs from these systems as it is designed to operate with a consistent intermittent power source (artificial lighting) that runs every day for a prescribed minimum period. As such, the invention can provide higher reliability, higher output power, and smaller energy storage relative to the prior art.

In another of its aspects, the present invention provides light weight energy storage. Power is stored in lightweight high energy density rechargeable batteries. The current preferred battery chemistry is lithium iron phosphate for its high energy density and operational stability. Other applicable battery types include alternate lithium chemistries, sodium chemistries, and solid-state batteries. Lithium battery technology enables sufficient energy storage because its energy density is approximately twice as high as the prevailing lead-acid chemistry that is commonly deployed in UPS-type devices. Lithium battery technology became financially feasible for the invention within the last 5 years due to battery manufacturing advances in the automotive industry and their commercial popularity in electric golf carts, recreational vehicles, and pleasure boats.

The present invention provides a compact form factor such that the invention can be mounted to a standard street light pole, wall, or similar structure without the requirement to install additional civil or structural infrastructure to support the invention. A small pole mountable enclosure contains all required equipment for the invention. The invention can be shipped fully assembled to an end user and be mounted directly on a pole or a wall. Weight is minimized to ensure that the intended pole or structure can support the invention. This small size and light weight is achieved by using a consistent intermittent input power source and by using energy dense storage batteries.

The device of the present invention may be ruggedized to withstand an outdoor environment including temperature, humidity, precipitation, and wind factors. Component selection for the invention is such that the whole system is environmentally hardened and can operate nominally over wide temperature ranges. The enclosure is designed to provide insulation, heat, and ventilation as required to ensure that the internal climate is suitable for the storage and operation of the selected components.

Lithium battery chemistry is rated for a higher operating temperature relative to lead-acid batteries which facilitates operation in hot climates. Lithium battery chemistries are typically not suitable for outdoor installations as they cannot be safely charged in temperatures below 0 degrees Celsius. The invention overcomes this challenge by including heating devices to keep the batteries above minimum thresholds in all operating temperature ranges. The control and power consumption of the heating and cooling in the enclosure is specially designed to minimize the electrical consumption to keep the required battery size and total invention weight and size to a minimum.

In another of its aspects, the invention provides continuous electrical power to an electrical load. The invention collects electrical energy from an artificial lighting power source and stores this energy chemically. The stored energy is then used to continue supplying continuous power to the electrical load when the artificial lighting power source is not available, for example when switched off.

The invention can be installed by an end user on a pole, wall, or similar structure in a matter of hours and immediately provide continuous power to the selected electrical loads.

The invention can be used for temporary or permanent installations.

In addition to roadway and highway lighting, the invention can be used in any other area that has artificial lighting including public areas, parks, walking trails, parking lots, industrial yards, buildings, airports, marine facilities, tunnels, sports facilities, or similar. The invention can supply electrical power to any type of electrical load. Potential uses include closed circuit television cameras; vehicle, pedestrian, or cyclist traffic sensors or counters; intelligent traffic system devices; programable logic controllers; supervisory control and data acquisition devices; network equipment; cellular and satellite modems; wired modems; emergency telephone stations; flashing pedestrian crossing light systems; navigational lights and systems; aerial obstruction lights and systems; environmental sensors; and irrigation controllers; among others.

The operating modes and their characteristics are described in Table 2 below.

TABLE 2
Operating Modes and Characteristics of the Invention

| | Off/Storage/ | Charging | Discharging |
|---|---|---|---|
| Component | Shipping Mode | Mode | Mode |
| Daylight status | Varies | Nighttime | Daytime |
| Artificial lighting | Absent | On | Off |
| power source | | | |
| Enclosure (6) | At or near ambient | Heating, cooling, or | Heating, cooling, or |
| | temperature and | neither as required to | neither as required to |
| | humidity. | maintain the operating | maintain the operating |
| | | temperature range. | temperature range. |
| Charger (3) | Inactive | Collecting power from | Inactive |
| | | the artificial lighting | |
| | | power source, | |
| | | supplying power to | |
| | | the electrical load | |
| | | (potentially via the | |
| | | power converter (2) if | |
| | | so equipped), and | |
| | | charging the battery (1). | |
| Battery (1) | Inactive | Converting electrical | Releasing electrical |
| | | energy into stored | energy from stored |
| | | chemical energy. | chemical energy. |
| Power | Inactive | Converting power | Converting power input |
| converter (2) (If | | input from charger | from battery output to |
| required) | | output to desired | desired voltage and |
| | | voltage and current type. | current type. |
| Incoming status | Off | On | Off |
| light (5) | | | |
| Outgoing status | Off | On | On |
| light (5) | | | |
| Power output to | Off | On | On |
| electrical load | | | |

The invention can be varied to suit the intended climate, cost, and client requirements.

Enclosures may be fabricated from painted steel for affordability, from aluminum for corrosion resistance and to reduce weight, from stainless steel for corrosion resistance while maintaining durability, or from PVC, fiberglass, or polyester for corrosion resistance, to reduce weight, and to enable wireless communications from devices located in the enclosure.

The invention may be provided with higher ratings of electrical ingress protection (such as NEMA 3R, 4X and IEC IP 65, 66, 67, 68 and 69) to allow for better weather seals in harsh environments.

There may be provided a powder coating on the enclosure for better corrosion protection and appearance.

The enclosure may be enlarged to provide space for the end user's electrical load/hardware, and it may be lockable so that the invention is secure at ground level.

There may be additional insulation, heating, and cooling provisions to deploy the invention in extreme temperature ranges. Alternatively, no insulation or heating could be provided to allow for a simpler, smaller, more efficient enclosure. This latter option will have an increased lower ambient temperature limit. Similarly, there could be provided no cooling to allow for a simpler, smaller, more efficient enclosure. This option will have a decreased upper ambient temperature limit.

The invention may be provided with a pre-wired power tap module that plugs directly into the receptable that is built into the top of most roadway light fixtures. This enables rapid installation without requiring an electrical permit or an electrician for the installation.

The system may include a standard receptacle in the enclosure so that the end user can plug their electrical load directly into the receptacle without the need for hard wiring. The system may include a cellular or satellite modem in the enclosure so that the product provides a continuous power supply and internet or telephone connectivity for electrical devices. The invention may provide Bluetooth, Wi-Fi, or network monitoring of the battery, charger, or power converter.

Additional battery capacity may be provided to allow for power outages without interruption to output power.

According to an alternate embodiment of the invention, there may be provided alternate topology using a line interactive combination of charger and power converter to pass line voltage through when it is available. This topology offers less electrical isolation (protection for the electrical load) than the original topology but results in lower required charging currents/input power.

A light fixture may be installed on the enclosure to provide area lighting.

There may be provided a custom integrated enclosure, battery, and electronics design to form a more compact enclosure. Custom electronics may be provided for the charger or power converter that are thermally connected to the enclosure exterior to enable direct radiant cooling to the ambient air outside of the enclosure.

The invention may use a multipurpose inverter-charger component instead of discrete inverter and charger components.

Modified versions of the enclosure may be provided to reduce the impact on pole wind loading including using a tall, skinny enclosure, or adding curved aerodynamic surfaces.

The invention may use custom component sizing to suit alternate intermittent input power supplies such as solar photovoltaics, wind generation, micro hydro, electrothermal processes, or fossil fuel power generators.

The battery may be replaced with high energy density capacitors such as supercapacitors or ultracapacitors to increase invention cycle life. Alternatively, the invention may use lead-acid batteries as the battery format to reduce invention cost.

Filters may be added to the outgoing power feeds to increase output electrical power quality and/or power factor. Filters may be added to the incoming power feeds to increase input electrical power quality and/or power factor.

It will be appreciated by those skilled in the art that other variations of the preferred embodiments may also be practiced without departing from the scope of the invention.

1. A continuous electrical power supply apparatus for providing uninterrupted power to an electrical load from a periodically switched intermittent power source, comprising:
an electrical energy storage device;
an electrical energy storage device charger configured to receive electrical power from the intermittent power source and to charge the electrical energy storage device during periods when the intermittent power source is energized;
an output power circuit configured to supply electrical power from the electrical energy storage device to the electrical load when the intermittent power source is or is not energized; and
an enclosure housing the electrical energy storage device, electrical energy storage device charger, and output power circuit;
wherein the battery is sized to power the electrical load during periods when the intermittent power source is de-energized, and
wherein the electrical energy storage device charger is configured to recharge the electrical energy storage device during a limited charging window corresponding to the energized period of the intermittent power source such that the electrical load receives substantially continuous electrical power.

2. The apparatus of claim 1, wherein the intermittent power source is selected from the group of electrical lighting circuits comprising roadway electric lighting circuits, parking lot electric lighting circuits, tunnel electric lighting circuits, airport electric lighting circuits, and industrial yard electric lighting circuits that are energized during nighttime hours and de-energized during daytime hours.

3. The apparatus of claim 1, wherein the intermittent power source is a is a fuel generator powered by an internal combustion engine, a fuel cell, or thermoelectric processes.

4. The apparatus of claim 1, wherein the intermittent power source is a renewable resource such as solar, wind, or micro hydro.

5. The apparatus of claim 1, wherein the electrical storage device is selected from the group of devices comprising a battery, a super capacitor, and an ultracapacitor.

6. The apparatus of claim 5, wherein the battery comprises a lead-acid battery or a rechargeable lithium iron phosphate battery configured for at least 3,650 deep discharge cycles.

7. The apparatus of claim 1, wherein the output power circuit comprises a power converter configured to convert electrical energy storage device output power to a voltage or current type required by the electrical load.

8. The apparatus of claim 7, wherein the power converter comprises at least one of: a DC-AC converter, a DC-DC converter, a voltage regulator, a modified sine wave inverter, or a pure sine wave inverter.

9. The apparatus of claim 1, wherein the enclosure is weatherproof and configured for outdoor installation on a pole, wall, or similar structure.

10. The apparatus of claim 1, wherein the enclosure further comprises environmental conditioning components configured to maintain the internal components within an operational temperature range.

11. The apparatus of claim 10, wherein the environmental conditioning components comprise at least one of a heater, fan, insulation layer, thermostat, or ventilation component.

12. The apparatus of claim 10, wherein the enclosure is custom designed to enclose the electrical load devices as well as the power source to reduce the required infrastructure at the installation site.

13. The apparatus of claim 1, wherein the charger is configured to recharge the electrical energy storage device from a depleted state in less than six hours.

14. The apparatus of claim 1, wherein the electrical energy storage device is configured to supply electrical power to the electrical load for a duration of at least 12 and up to 18 hours without input power.

15. The apparatus of claim 1, wherein the apparatus further comprises a receptacle configured to allow the electrical load to be connected by plug.

16. The apparatus of claim 1, further comprising a communication module configured to provide wireless connectivity for monitoring or controlling the apparatus, wherein the communication module comprises at least one of a cellular modem, satellite modem, Bluetooth interface, Wi-Fi interface, or network interface.

17. The apparatus of claim 1, further comprising a prewired power tap module configured to connect directly to a receptacle associated with a light fixture.

18. A method of providing continuous electrical power to an electrical load from a switched intermittent power source, comprising:
drawing electrical power from the intermittent power source during periods when the intermittent power source is energized;
charging a battery with the drawn electrical power;
supplying electrical power from the battery to the electrical load during periods when the intermittent power source is not energized; and
repeating the charging and supplying steps on a daily cycle corresponding to the switching schedule of the intermittent power source.

19. The method of claim 18, wherein the battery is recharged during a nighttime period and the electrical load is powered from the battery during a daytime period.

20. The method of claim 18, further comprising conditioning an interior environment of an enclosure containing the battery to maintain the battery above minimum charging and discharging temperatures.
